(19) United States
(12) Patent Application Publication
(10) Pub. No.: US 2009/0264594 A1
(43) Pub. Date: Oct. 22, 2009

(54) Aromatic Sulfone Polymer Composition Comprising Tetrafluoroethylene Polymer Particles

(75) Inventors: Shari Weinberg, Atlanta Fulton, GA (US); Thomas H. Schwab, Cumming, GA (US); Tiziana Poggio, Montechiaro d'Acqui (IT); Valeri Kapeliouchko, Alessandria (IT); Jean-Raphael Caille, Namur (BE); Daniel Gloesener, Boninne (BE)

Correspondence Address: Solvay;c/o B. Ortego - IAM-NAFTA, 3333 Richmond Avenue, Houston, TX, 77098-3099, US

(73) Assignee: SOLVAY (SOCIETE ANONYME), Brussels (BE)

(21) Appl. No.: 12/295,627

(22) PCT Filed: Dec. 4, 2006
(86) PCT No.: PCT/EP2006/069242

§ 371 Date: Sep. 30, 2008

Related U.S. Application Data
(60) Provisional application No. 60/741,913, filed on Dec. 5, 2005.

(51) Int. Cl. C08L 81/06

(52) U.S. Cl. 525/186; 525/189

(57) ABSTRACT

The invention relates to an aromatic sulfone polymer composition comprising
at least one aromatic sulfone polymer [polymer (P)];
from 0.02 to less than 10 wt %, based on the total weight of the composition, of a tetrafluoroethylene (TFE) polymer [polymer (F)] under the form of nanoparticles, wherein said nanoparticles have an average primary particle size of less than 100 nm.

The compositions of the invention advantageously display an unexpected combination of excellent mechanical properties, excellent chemical resistance, excellent optical properties (transparency and/or colorability) and low flammability.

Still an object of the invention is a process for manufacturing aromatic sulfone polymer compositions. According to a preferred embodiment, said process comprises a co-coagulating step of an aromatic sulfone polymer solution with TFE nanoparticles. Still objects of the invention are the articles comprising the composition as above specified.

### CROSS-REFERENCE TO RELATED APPLICATIONS

The present application claims the benefit of U.S. application Ser. No. 60/741,913 filed Dec. 5, 2005, herein incorporated by reference.

### FIELD OF THE INVENTION

The present invention relates to a polymer composition which exhibits usually high transparency, excellent flame resistance, and lightweight and outstanding mechanical properties, particularly useful for aircraft interior applications.

The present invention also relates to a method of manufacturing an aromatic sulfone polymer composition.

The present invention finally relates to a shaped article comprising said polymer composition.

### BACKGROUND

Engineering plastics are widely used for aircraft interior applications in many components, such as window covers, ceiling panels, sidewall panels and wall partitions, display cases, mirrors, sun visors, window shades, stowage bins, stowage doors, ceiling overhead storage lockers, serving trays, seat backs, cabin partitions, and ducts. Key material properties are transparency and/or low color, lightweight, resistance to scratching, strength and stiffness, and chemical resistance and flammability requirements.

Sulfone polymers, in particular polyphenylsulfones (PPSU) have gained increased interest as aircraft interior materials, as they provide for high strength and stiffness at high temperature, they exhibit outstanding toughness among other polymers of same temperature class, they possess very good chemical resistance (so that they generally withstand exposure to cleaning fluids in aircraft industry), can be easily processed in the melt either for making injection molded articles or for extrusion of films and sheets, have excellent transparency and ease of colorability; moreover sulfone polymers are inherently flame-resistant materials with low smoke emission.

United States Government standards for the flame resistance of construction materials used for aircraft interiors are set out in the 1986 amendments to Part 25-Airworthiness Standards—Transport Category Airplanes of Title 14, Code of Federal Regulations (see 51 Federal Register 26206, Jul. 21, 1986 and 51 Federal Register 28322, Aug. 7, 1986). The flammability standards are based on heat calorimetry tests developed at Ohio State University (hereinafter “OSU Tests”). Such OSU Tests are described in the above-cited amendments to 14 CFR Part 25 and are incorporated herein by reference. These tests measure the two minute total heat release (THR) (in kilowatts minute per square meter of surface area, KW.min/m²) as well as the maximum heat release rate (HRR) (in kilowatts per square meter of surface area, KW/m²) over the first five minutes for the material being tested, when burned under a specified set of conditions. The 1986 standards required engineering thermoplastics to have both of these heat release measurements under 100. The new 1990 compliance standards will allow a maximum of 65 for each of the two heat release measurements (that is to say, THR≦65 KW.min/m² and HRR≦65 KW/m²). Hence, a need exists to develop new thermoplastic compositions that will be able to meet these flammability standards, and yet display at the same time such other desirable features as toughness, chemical, solvent and cleaner resistance, and ease of fabrication into finished components.

Aromatic sulfone polymers, in particular polyphenylsulfone, offer today the best performances of commercially available transparent materials. Nevertheless, heat release performances of sulfone polymers are still inferior to those of opaque plastic materials containing appropriate conventional flame retardants.

By addressing the critical challenges of weight reduction, transparency and safety, several approaches can be prosecuted for improving the heat release performances of sulfone polymers.

Flame retarding additives such as triphenyl phosphate or melamine cyanurate, which generally possess low flammability have been mixed with engineering thermoplastics to reduce flammability of the thermoplastics. However, a blend of such a low flammability additive with high performance engineering thermoplastics often does not yield a useable transparent flame-resistant composition. For example, the low flammability additive may not be compatible, i.e. miscible with the engineering thermoplastic, at additive concentrations necessary to achieve significant flame retardance, or the additive may not be stable at the processing temperatures of the engineering thermoplastic. Furthermore, inorganic additives such as TiO₂, ZnO or Zinc borate offer reductions in heat release only at high loading levels (effect on flammability being often merely a reduction due to dilution), but lightweight, processability and transparence advantages of polysulfone materials are consequently lost. Minimization of specific gravity is very important in aircraft applications.

There is thus a need in the interior aircraft materials for transparent and/or translucent materials having reduced heat release during combustion, good processability and low specific density.

Fluorocarbon resins have been used in the past for the flammability improvement of aromatic sulfone polymers.

U.S. Pat. No. 5,204,400 discloses flame retardant thermoplastic compositions comprising a poly(biphenyl ether sulfone) of general formula:

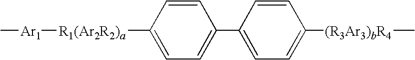

wherein R₁ though R₄ are —O—, —SO₂—, —S—, —C(O)—, with the provision that at least one of R₁ though R₄ is —SO₂— and at least one of R₁ though R₄ is —O—; Ar₁, Ar₂, Ar₃ are arylene radicals containing 6 to 24 carbon atoms, together with anhydrous Zinc borate and a fluorocarbon polymer employed in the form of finely divided solids having a particle size of less than about 5 μm. A polytetrafluoroethylene (PTFE) of low molecular weight (non fibrillating), available under the tradename POLYMIST® F5A is used in the examples; POLYMIST® F5A PTFE is a micronized powder having an average particle size of 4.0 μm.

U.S. Pat. No. 5,916,958 discloses compositions comprising a poly(biphenyl ether sulfone) of formula:

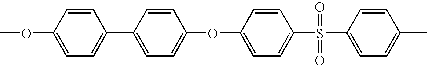

together with a fluorocarbon polymer and titanium dioxide, which exhibit enhanced flame retardant characteristics and which are useful for a wide variety of applications, such as to make aircraft interior parts. The fluorocarbon polymer is preferably a PTFE employed in the form of finely divided solids having a particle size of less than about 5 μm, such as POLYMIST® F5A PTFE.

U.S. Pat. No. 6,503,988 discloses flame resistive composition comprising a flammable thermoplastic resin, a flame retardant, and a polytetrafluoroethylene fine powder comprising particles of 0.05 to 1 μm as antidripping agent. Among a long list, polysulfone resins are mentioned as suitable flammable thermoplastic resin.

U.S. Pat. No. 6,482,880 discloses poly(biphenyl ether sulfone) resins having improved resistance to yellowing; exemplified compositions comprise, inter alia, a PTFE, namely POLYMIST® F5A PTFE.

Nevertheless, dispersing PTFE materials in aromatic sulfone polymer matrix is not easy; this can affect the efficiency in reducing the heat release; moreover, the resulting compositions, as described in the prior art, exhibit a pearlescent opaque appearance. These materials are thus difficult to color and cannot be used in application where transparency is required.

There is thus a need in the interior aircraft materials for transparent and/or translucent (that is to say transparent in only one direction) materials having reduced heat release during combustion, good processability and low specific density.

According to the present invention, the above-mentioned difficulties and other are remarkably overcome by an aromatic sulfone polymer composition comprising:
at least one aromatic sulfone polymer [polymer (P)];
from 0.02 to less than 10 wt %, based on the total weight of the composition, of a tetrafluoroethylene (TFE) polymer [polymer (F)] under the form of nanoparticles, wherein said nanoparticles have an average primary particle size of less than 100 nm.

The compositions of the invention advantageously display an unexpected combination of excellent mechanical properties, excellent chemical resistance, excellent optical properties (transparency and/or colorability) and low flammability. Moreover, compositions according to the invention are notably easy to melt-fabricate, providing molded articles having smooth and aesthetically pleasing surface characteristics. The invented materials are advantageously readily pigmented in a wide range of colors, and are useful in a number of applications, in particular for the construction of various panels and parts for aircraft interiors.

For the purpose of the invention, the term “polymer” is intended to denote any material consisting essentially of recurring units, and having a molecular weight above 3000.

For the purpose of the invention, the term “oligomer” is intended to denote any material consisting essentially of recurring units, and having a molecular weight below 3000.

The composition of the invention is advantageously transparent.

The term transparent, used as synonymous of clear, is a measure of the ability of a material to transmit image-forming light. It may be thought of as the distinctness with which an object appears when viewed through the material. Therefore, transparency depends on the linearity of the passage of light rays through the material.

Generally, when light interacts with matter, it can be reflected, absorbed, scattered, or transmitted. An object is generally described as “transparent” if a significant fraction of the incident light is transmitted through the object. An object is considered “opaque” if very little light is transmitted through it. And object is considered “translucent” if some light passes through but not in a way that a coherent image can be seen through it. Typically, this occurs if light must take a circuitous path through the object, scattering from embedded particles, defects or grain boundaries.

Thus, the common characteristic of the inventive composition that makes it transparent is that it (1) does not reflect much (i.e. advantageously less than 50%, preferably less than 30%) of incoming light from its surface, (2) does not absorb much (i.e. advantageously less than 50%, preferably less than 30%) of said incoming light, and (3) is uniform enough not to scatter much (i.e. advantageously less than 50%, preferably less than 30%) of said incoming light.

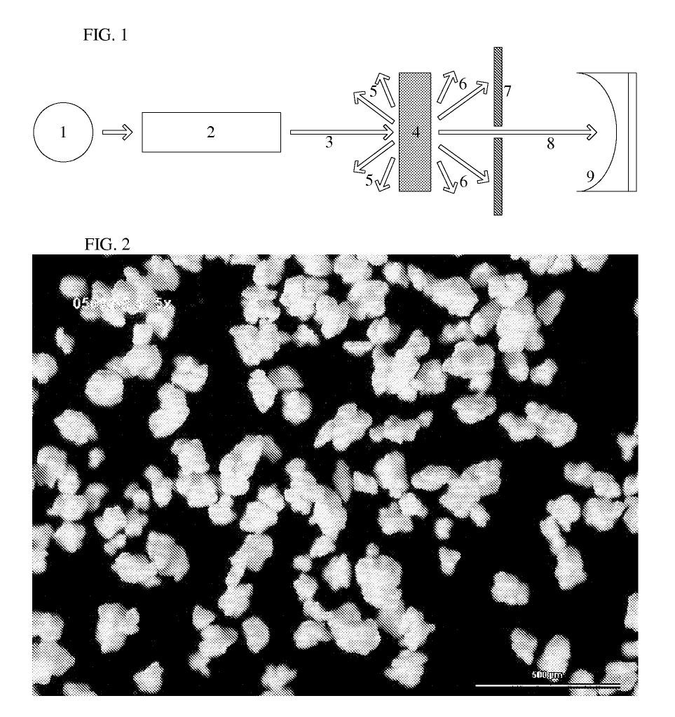

According to ASTM D 1746, transparency can be determined by small-angle scattering. A typical assembly for determining transparency is sketched in FIG. 1. A light source (1) emits a light radiation which is passed though a collimator (2) to guide incident beam towards the sample specimen (4); intensity of incident light beam (3) Iᵢ and of transmitted light (8) deflected of less than 0.1 degree Iᵣ is measured; an aperture (7) avoids reflected (5) and scattered or deflected (6) light to reach the detector (9).

Transparency is thus expressed as percentage as follows

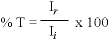

The composition of the invention have a transparency of advantageously more than 40%, preferably of more than 50%, more preferably more than 60%, still more preferably of more than 65%, even more preferably of more than 70%, according to ASTM D 1746, when measured on sheets having a thickness of 100 μm.

Excellent results have been obtained with composition having a transparency of more than 80%, when measured on sheets having a thickness of 100 μm.

When the composition of the invention has a transparency of less than 40%, when measured on sheets having a thickness of 100 μm, it cannot be used for aircraft applications wherein transparency is required, because of its low clarity and its pearlescent opaque appearance.

The composition of this invention may be further characterized by its combination of desirable properties, including notably:
1. Excellent heat release characteristics as determined by the procedures of Part 25 of Title 14 of the Code of Federal Regulations (14 CFR Part 25). The compositions of the instant invention advantageously routinely meet the 65/65 1990 compliance levels in these standards for the two minutes total heat release and the maximum heat release rate (that is to say, THR≦65 KW.min/m² and HRR≦65 KW/m²). The preferred compositions of the invention show superior heat release performance and vastly exceed the 1990 standards;
2. Toughness and mechanical processability. The unscratched impact values of the inventive compositions, as determined by the procedures of ASTM D3029-84 and Boeing Airplane Co. Specification BBS 7271 are advantageously equal to or greater than about 80 inch/lb. The compositions are also advantageously readily melt-fabricated to produce molded articles having aesthetically pleasing surfaces; and
3. Chemical resistance. As defined in Boeing Airplane Co. Specification BMS-8-321, Sect. 8.2., thermoplastic samples for aircraft interiors are tested by exposure, while under stress, to each of four solvents (toluene, methyl ethyl ketone (MEK), Jet Fuel A and Skydrol). A thermoplastic “fails” to meet this Boeing Specification if any of the following occurs upon exposure to any one of the four solvents: swelling, shrinking, cracking, crazing or breaking. The preferred compositions of the invention do not fail when exposed to these solvents under the Boeing test conditions.

For the purpose of the invention, the terms “aromatic sulfone polymer (P)” are intended to denote any polymer, comprising recurring units (R), at least 50% wt of said recurring units comprising at least one group of formula 1

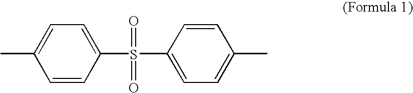

In a first preferred embodiment of the invention, at least 50% wt of the recurring units (R) of aromatic sulfone polymer (P) are recurring units (R1), in their imide form (R1-A) and/or amic acid forms [(R1-B) and (R1-C)]

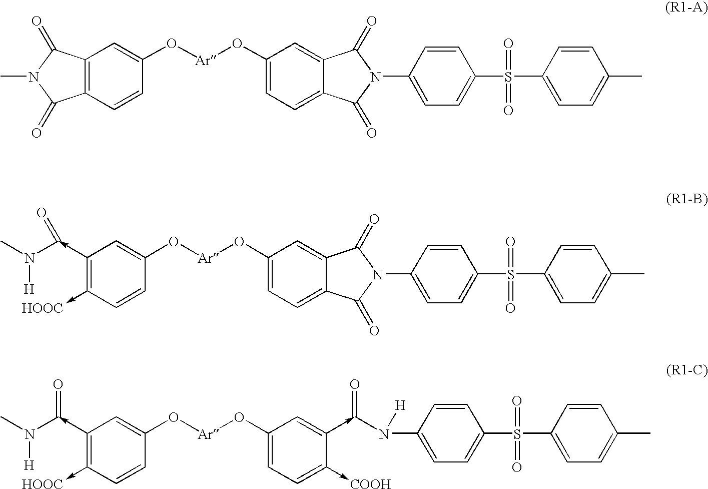

wherein:
the → denotes isomerism so that in any recurring unit the groups to which the arrows point may exist as shown or in an interchanged position;
Ar″ is chosen among the following structures

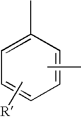

with the linking groups being in ortho, meta or para position and R′ being a hydrogen atom or an alkyl radical comprising from 1 to 6 carbon atoms,

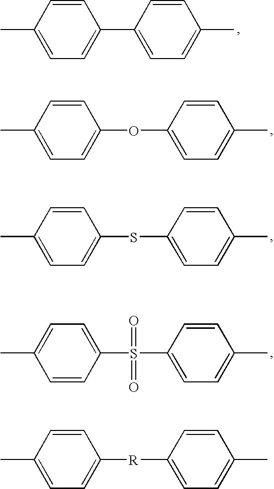

with R being an aliphatic divalent group of up to 6 carbon atoms, such as methylene, ethylene, isopropylene and the like,
   and mixtures thereof.

Aromatic sulfone polymer (P) according to the first preferred embodiment of the invention comprises at least 50% wt. preferably at least 70% wt. more preferably at least 75% wt of recurring units (R1), still more preferably, it contains no recurring unit other than recurring units (R1).

In a second preferred embodiment of the invention, at least 50% wt of the recurring units (R) of aromatic sulfone polymer (P) are recurring units (R2) and/or recurring units (R3):

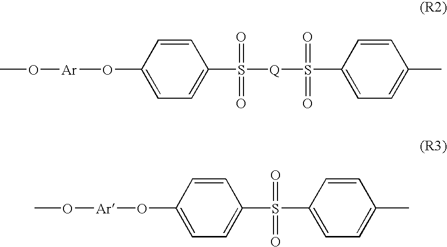

wherein:
Q is a group chosen among the following structures:

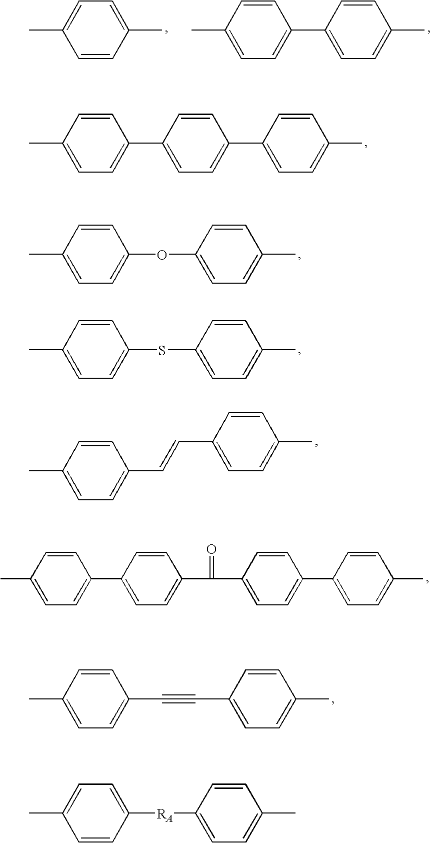

with R_{A} being:

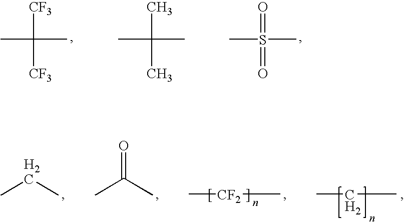

with n=integer from 1 to 6, or an aliphatic divalent group, linear or branched, of up to 6 carbon atoms; and mixtures thereof,
Ar is a group chosen among the following structures:

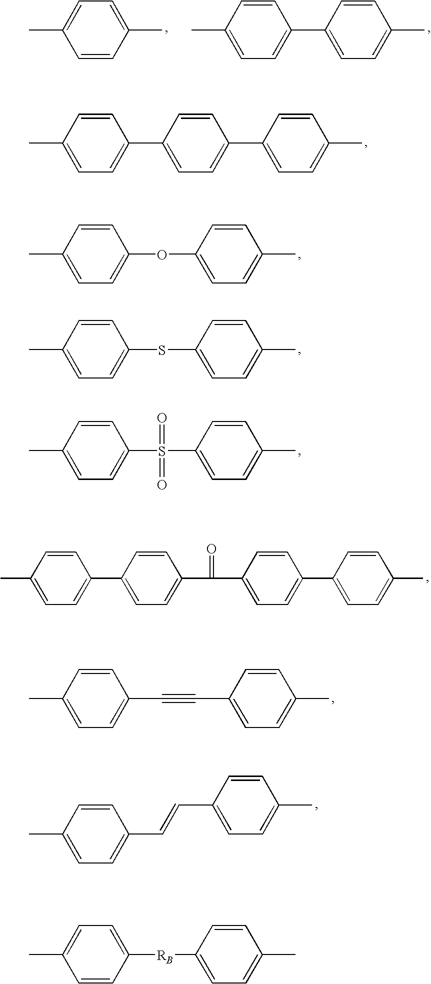

with R_{B} being:

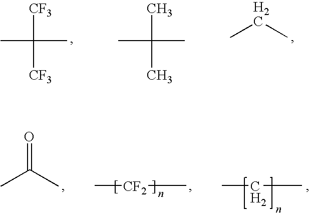

with n=integer from 1 to 6, or an aliphatic divalent group, linear or branched, of up to 6 carbon atoms; and mixtures thereof,
Ar′ is a group chosen among the following structures:

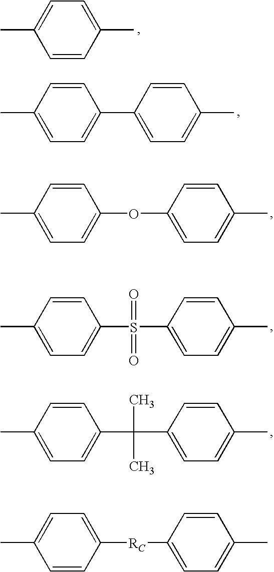

with R_{C} being:

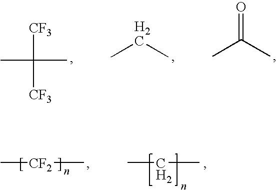

with n=integer from 1 to 6, or an aliphatic divalent group, linear or branched, of up to 6 carbon atoms;
   and mixtures thereof.

Recurring units (R2) are preferably chosen from:

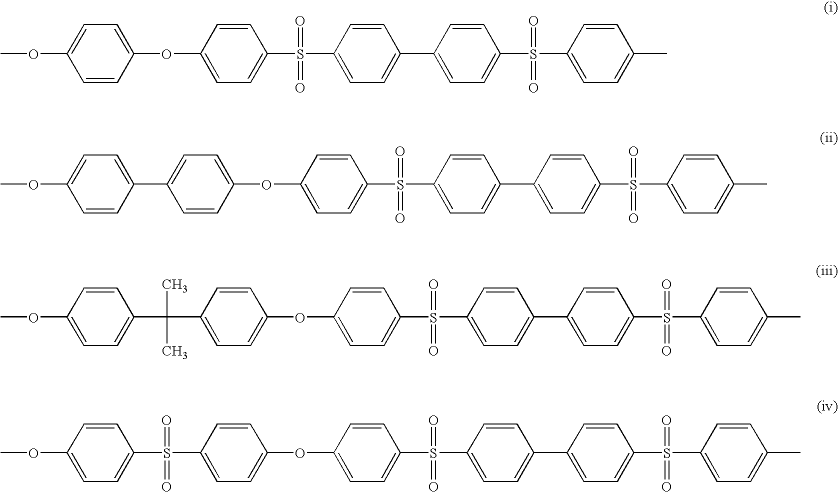

and mixtures thereof.

Recurring units (R3) are preferably chosen from:

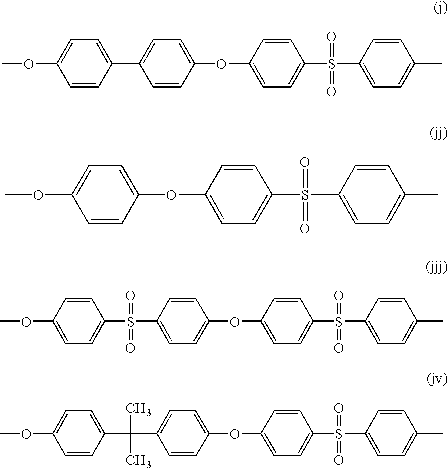

and mixtures thereof.

Most preferably, recurring units (R3) are units (j) as above detailed.

Aromatic sulfone polymer (P) according to the second preferred embodiment of the invention comprises advantageously at least 50% wt. preferably at least 70% wt. more preferably at least 75% wt of recurring units (R2) and/or (R3), still more preferably, it contains no recurring unit other than recurring units (R2) and/or (R3).

Good results were obtained with aromatic sulfone polymer (P) the recurring units of which are recurring units (ii) (polybiphenyletherdisulfone, herein after), with aromatic sulfone polymer (P) the recurring units of which are recurring units (j) (polyphenylsulfone or PPSU, hereinafter), with aromatic sulfone polymer (P) the recurring units of which are recurring units (jj) (polyetherethersulfone, hereinafter), with aromatic sulfone polymer (P) the recurring units of which are recurring units (jjj) and, optionally in addition, recurring units (jj) (polyethersulfone, hereinafter), and with aromatic sulfone polymer (P) the recurring units of which are recurring units (jv) (polysulfone, hereinafter).

Polyphenylsulfone is notably available as RADELL® R PPSU from Solvay Advanced Polymers, L.L.C. Polysulfone is notably available as UDELL® PSF from Solvay Advanced Polymers, L.L.C. Polyethersulfone is notably available as RADELL® A PES from Solvay Advanced Polymers, L.L.C. Polybiphenyletherdisulfone is notably available as SUPRADEL™ HTS from Solvay Advanced Polymers, L.L.C.

Preferably, aromatic sulfone polymer (P) according to the second preferred embodiment of the invention comprises advantageously at least 50% wt. preferably 70% wt. more preferably 75% wt of recurring units (R3), still more preferably, it contains no recurring unit other than recurring units (R3).

More preferably, aromatic sulfone polymer (P) is chosen among the group consisting of polysulfone, polyphenylsulfone, polyethersulfone, copolymers and mixtures thereof.

Most preferably, aromatic sulfone polymer (P) is a polyphenylsulfone.

The aromatic sulfone polymer (P) is present in the composition of the invention in an amount of advantageously more than 60 wt %, preferably of more than 70 wt %, most preferably of more than 80 wt %, based on the total weight of the composition.

The aromatic sulfone polymer (P) is present in the composition of the invention in an amount of advantageously less than 99 wt %, preferably of less than 98 wt %, most preferably of less than 96 wt %, based on the total weight of the composition.

Good results have been obtained with composition comprising from 60 to 99 wt % of polymer (P).

Excellent results have been obtained with composition comprising from 80 to 99 wt % of polymer (P).

The TFE polymer (F) is advantageously chosen among homopolymers of tetrafluoroethylene (TFE) or copolymers of TFE with at least one ethylenically unsaturated comonomer [comonomer (CM)], said comonomer being present in the TFE copolymer in an amount from 0.01 to 3% by moles, preferably from 0.01 to 1% by moles, with respect to the total moles of TFE and comonomer (CM).

In the rest of the text, the expressions “ethylenically unsaturated comonomer” and “comonomer (CM)” are understood, for the purposes of the present invention, both in the plural and the singular, that is to say that they denote both one or more than one comonomer (CM).

The comonomer (CM) can comprise at least one fluorine atom (fluorinated comonomer) or can be free of fluorine atoms (hydrogenated comonomer).

Among hydrogenated comonomers mention can be notably made of ethylene; propylene; acrylic monomers, such as for instance methylmethacrylate, (meth)acrylic acid, butylacrylate, hydroxyethylhexylacrylate; styrene monomers, such as for instance styrene.

Non limitative examples of suitable fluorinated comonomers are notably:
C₃-C₈ perfluoroolefins, such as hexafluoropropene;
C₂-C₈ hydrogenated fluoroolefins, such as vinyl fluoride (VF), vinylidene fluoride (VDF), 1,2-difluoroethylene and trifluoroethylene;
perfluoroalkylethylenes complying with formula CH₂═CH—R_{f0}, in which R_{f0} is a C₁-C₆ perfluoroalkyl;
chloro- and/or bromo- and/or iodo-C₂-C₆ fluoroolefins, like chlorotrifluoroethylene (CTFE);
(per)fluoroalkylvinylethers complying with formula CF₂═CFOR_{f1} in which R_{f1} is a C₁-C₆ fluoro- or perfluoroalkyl, e.g. CF₃, C₂F₅, C₃F₇;
CF₂═CFOX₀ (per)fluoro-oxyalkylvinylethers, in which X₀ is a C₁-C₁₂ alkyl, or a C₁-C₁₂ oxyalkyl, or a C₁-C₁₂ (per)fluorooxyalkyl having one or more ether groups, like perfluoro-2-propoxy-propyl;
(per)fluoro-oxyalkylvinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional (per)fluoroalkylvinylethers complying with formula CF₂═CFOY₀, in which Y₀ is a C₁-C₁₂ alkyl or (per)fluoroalkyl, or a C₁-C₁₂ oxyalkyl, or a C₁-C₁₂ (per)fluorooxyalkyl having one or more ether groups and Y₀ comprising a carboxylic or sulfonic acid group, in its acid, acid halide or salt form;
fluorodioxoles of formula:

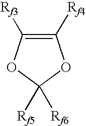

wherein each of R_{f3}, R_{f4}, R_{f5}, R_{f6}, equal of different each other, is independently a fluorine atom, a C₁-C₆ fluoro- or perfluoroalkyl, optionally comprising one or more oxygen atom, e.g. —CF₃, —C₂F₅, —C₃F₇, —OCF₃, —OCF₂CF₂OCF₃; preferably a fluorodioxole complying with formula here above, wherein R_{f3} and R_{f4} are fluorine atoms and R_{f5} and R_{f6} are perfluoromethyl groups (—CF₃), or a fluorodioxole complying with formula here above, wherein R_{f3}, R_{f5} and R_{f6} are fluorine atoms and R_{f4} is a perfluoromethoxy group (—OCF₃).

The fluorinated comonomer can further comprise one or more other halogen atoms (Cl, Br, I). Shall the fluorinated comonomer be free of hydrogen atom, it is designated as per(halo)fluorocomonomer. Shall the fluorinated monomer comprise at least one hydrogen atom, it is designated as hydrogen-containing fluorinated comonomer.

The comonomer (CM) is preferably a fluorinated comonomer, more preferably a per(halo)fluorocomonomer.

Most preferably, the comonomer (CM) is chosen among hexafluoropropylene, perfluoromethylvinylether, perfluoropropylvinylether, perfluorodioxole of formula:

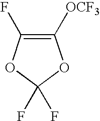

and mixtures thereof.

The polymer (F) is advantageously non melt-processable.

For the purposes of the present invention, by the term “non melt-processable” is meant that the polymer (F) cannot be processed (i.e. fabricated into shaped articles such as films, fibers, tubes, wire coatings and the like) by conventional melt extruding, injecting or casting means. Such typically requires that the dynamic viscosity at a shear rate of 1 s⁻¹ and at a temperature exceeding melting point of roughly 30° C., preferably at a temperature of Tₘ₂+(30±2° C.), exceed 10⁶ Pa×s, when measured with a controlled strain rheometer, employing an actuator to apply a deforming strain to the sample and a separate transducer to measure the resultant stress developed within the sample, and using the parallel plate fixture.

TFE polymer [polymer (F)] is present in the composition of the invention in an amount of less than 10 wt %, preferably of less than 7 wt %, most preferably of less than 4 wt %, based on the total weight of the composition.

TFE polymer [polymer (F)] is present in the composition of the invention in an amount of at least 0.02 wt %, preferably of at least 0.05 wt %, most preferably of at least 0.1 wt %, most preferably of at least 0.5 wt % based on the total weight of the composition.

Good results have been obtained with composition comprising from 0.02 to less than 10 wt % of polymer (F), based on the total weight of the composition.

Excellent results have been obtained with composition comprising from 0.5 to less than 4 wt % of polymer (F), based on the total weight of the composition.

Concentrations of the polymer (F) equal of above 10 wt %, with respect to the total weight of the composition, are undesirable since these amounts can adversely affect the moldability and can create a pearlescent effect, making color matching a problem.

For the purpose of the invention the term “particle” is intended to denote a mass of material that, from a geometrical point of view, has a definite three-dimensional volume and shape, characterized by three dimensions, wherein none of said dimensions exceed the remaining two other dimensions of more than 10 times. Particles are generally not equidimensional, i.e. are longer in one direction than in others.

Particles having nanometric dimension (i.e. average primary particle size of less than 1 μm), are generally referred as nanoparticles.

Nanoparticles of polymer (F) suitable for the purpose of the invention have an average primary particle size of less than 100 nm, preferably of less than 90 nm, more preferably of less than 80 nm, most preferably of less than 70 nm.

Nanoparticles of polymer (F) suitable for the purpose of the invention have an average primary particle size of advantageously more than 2 nm, preferably of more than 5 nm, more preferably of more than 10 nm, even more preferably of more than 15 nm, most preferably of more than 20 nm.

Good results have been obtained with polymer (F) nanoparticles having an average primary particle size of more than 10 nm and less than 100 nm.

Excellent results have been obtained with polymer (F) nanoparticles having an average primary particle size of more than 20 nm and less than 70 nm.

The average primary particle size can be measured by dynamic laser light scattering (DLLS) technique according to the method described in B. Chu “Laser light scattering” Academic Press, New York (1974), based on Photon Correlation Spectroscopy (PCS), following ISO 13321 Standard.

It is well-known to the skilled in the art that the PCS gives an estimation of the average hydrodynamic diameter. To the purpose of this invention, the term “average size” is to be intended in its broadest meaning connected with the determination of the hydrodynamic diameter. Therefore, this term will be applied with no limit to the shape or morphology of the polymer (F) nanoparticles (cobblestone, rod-like, spherical, and so on . . . ).

It should be also understood that, following the purposes of ISO 13321 Standard, the term “average particle size” of primary particles is intended to denote the harmonic intensity-averaged particle diameter X_{PCS}, as determined by equation (C.10) of annex C of ISO 13321.

As an example, the average primary particle size can be measured by using a Brookhaven Scientific Instrument BI9000 correlator and BISM goniometer and Argon Laser light source having a wavelength of 514.5 nm by Spectra-Physics. Primary average particle size is preferably measured on latex specimens, as obtained from microemulsion polymerization, suitably diluted with bidistilled water and filtered at 0.2 μm on Millipore filter.

For the avoidance of doubt, within the context of this invention, the term primary particle is intended to denote nanoparticles of polymer (F) which cannot be analyzed in agglomerations of smaller particles; primary particle are generally obtained during polymer (F) manufacture, as latex or dispersion in water.

Nanoparticles of polymer (F) are preferably obtained from a process comprising a microemulsion polymerization step, including:
a) preparing an aqueous microemulsion of perfluoropolyether (PFPE) in water with a fluorinated surfactant;
b) polymerizing a monomer mixture comprising TFE in a aqueous medium comprising said microemulsion and a water-soluble radical initiator.

Within the context of the present invention, the term perfluoropolyether (PFPE) is intended to denote an oligomer comprising recurring units (R*), said recurring units comprising at least one ether linkage in the main chain and at least one fluorine atom (fluoropolyoxyalkene chain).

Preferably the recurring units R* of the (per)fluoropolyether are selected from the group consisting of:
(I) —CFX—O—, wherein X is —F or —CF₃; and

(II) —CF₂—CFX—O—, wherein X is —F or —CF₃; and
(III) —CF₂—CF₂—CF₂—O—; and
(IV) —CF₂—CF₂—CF₂—CF₂—O—; and
(V) —(CF₂)ⱼ—CFZ-O— wherein j is an integer chosen from 0 and 1 and Z is a fluoropolyoxyalkene chain comprising from 1 to 10 recurring units chosen among the classes (I) to (IV) here above;
   and mixtures thereof.

The microemulsions of PFPE used in the process as above described are notably described in U.S. Pat. Nos. 4,864,006 and 4,990,283, whose disclosures are herein incorporated by reference. Otherwise, microemulsion of PFPE having non reactive end groups or end groups optionally containing 1 or more atoms of H, Cl instead of fluorine are described in U.S. Pat. No. 6,297,334.

The molecular weight of perfluoropolyethers (PFPE) which can be used can also be lower than 500, for example 300 as number average molecular weight. The microemulsions obtained with the use of PFPE having a low molecular weight, in the range of 350-600, preferably 350-500, can be used advantageously in the applications wherein their quantitative removal is required.

The surfactants which can be used both for preparing the microemulsion and during the polymerization, are (per)fluorinated surfactants known in the prior art and in particular are those described in the cited patents or those having one end group wherein one or more fluorine atoms are substituted by chlorine and/or hydrogen. Among (per)fluorinated surfactants, anionic (per)fluorinated surfactants, having a (per)fluoropolyether or (per)fluorocarbon structure, having for example carboxylic or sulphonic end groups salified with alkaline or alkaline-earth metals, cationic (per)fluorinated surfactants, for example quaternary ammonium salts, and non ionic (per)fluorinated surfactants, can be mentioned. These surfactants can also be used in admixture. Anionic (per)fluorinated surfactants are preferred and those having salified carboxylic end groups are more preferred.

Optionally in the process for preparing polymer (F) nanoparticles, iodinated and brominated chain transfer agents can be used. R_{f}^{¤}I₂ can for example be mentioned, wherein R_{f}^{¤} is a divalent perfluorocarbon moiety comprising from 4 to 8 carbon atoms.

Processes comprising a microemulsion polymerization step as described in U.S. Pat. No. 6,297,334, whose disclosures are herein incorporated by reference, are particularly suitable for preparing polymer (F) nanoparticles having an average primary particle size of less than 100 nm.

Polymer (F) nanoparticles are generally obtained as aqueous dispersions or latexes. Said nanoparticles can be further recovered and conditioned in further steps, like notably concentration and/or coagulation of polymer (F) latexes and subsequent drying and homogenization. It can happen to said nanoparticles to be converted to agglomerates (i.e. collection of primary particles) during above-mentioned recovery and conditioning steps of polymer (F) manufacture.

Should the polymer (F) nanoparticles not be submitted to conditions wherein agglomeration of primary particles occurs, then the average particles size of polymer (F) nanoparticles after recovery is equal to the average primary particles size of polymer (F).

On the contrary, should the polymer (F) nanoparticles be submitted to conditions wherein agglomeration of primary particles takes place, then the actual, macroscopic average particle size of the polymer (F) agglomerates can be different (notably larger) from the average primary particle size of the same.

The composition of the invention can further comprise TiO₂.

The titanium dioxide which can be used in the composition as above described is commercially available, and any suitable TiO₂ can be used. The average particle size of the TiO₂ is preferably below about 2 μm because higher particle sizes can deleteriously affect the physical properties of the polymer. More preferably, the average particle size of the titanium dioxide is inferior to 1 μm, still more preferably inferior to 0.100 μm. Nanoparticles of TiO₂ having average particle size of less than 100 nm gave excellent results when used in the composition of the invention.

Any of the available crystalline forms of the TiO₂ may be used, with the rutile form preferred due to its superior pigment properties.

The total amount of TiO₂ will preferably be below about 15 parts by weight per 100 parts by weight of polymer (P) to avoid compounding and processing difficulties. Preferred compositions employ about 4 to about 10 parts by weight TiO₂ per 100 parts by weight of polymer components [polymer (P) plus polymer (F)] since these materials have better processability.

Optionally, the composition described above can further comprise one or more of the following: processing aids, pigments, filling materials, electrically conductive particles, lubricating agents, heat stabilizer, anti-static agents, extenders, reinforcing agents, organic and/or inorganic pigments, and the like.

The composition of this invention may optionally include additional thermoplastics; according to an embodiment of the invention, the composition advantageously comprises an aromatic ether ketone polymers [polymer (K)]. Composition comprising polymer (K) will generally comprise from 20 to 60 weight parts of polymer (K) per 100 parts by weight of polymer (P).

For the purpose of the invention, the terms “aromatic ether ketone polymers” are intended to denote any polymer, comprising recurring units (R″), more than 50 wt % of said recurring units are recurring units (k-A), (k-B) and/or (k-C):

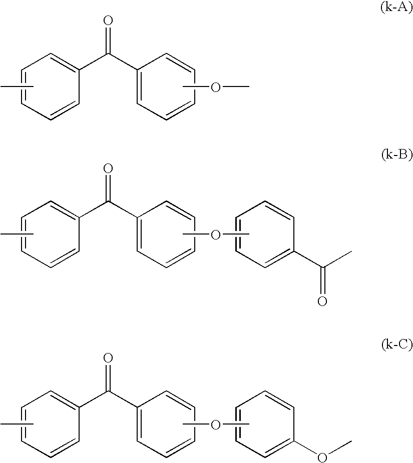

wherein the attachment of the ketone and/or ether groups to the aromatic ring as shown in (k-A), (k-B) and (k-B) will be understood to represent, independently at each occurrence, each of the possible ortho, meta and para configurations.

Preferably at least 70 wt %, more preferably at least 80 wt % of the recurring units (R″) of the polymer (K) suitable for the composition of the invention are recurring units (k-A), (k-B) and/or (k-C). Excellent results have been obtained with polymer (K) comprising no recurring units other than recurring units (k-A), (k-B) and/or (k-C).

Aromatic ether ketone polymers (K) are generally crystalline aromatic polymers, readily available from a variety of commercial sources. Methods for their preparation are well known, including the processes described for example in U.S. Pat. Nos. 3,441,538, 3,442,857, 3,516,966, 4,396,755 and 4,816,556. Preferably the polymer (K) is chosen among polyetheretherketones (PEEK) and polyetherketoneketone (PEKK).

A polyetheretherketone (PEEK) is a polymer (K) wherein more than 50 wt % of recurring units (R″) are recurring units (k-C).

A polyetherketoneketone (PEKK) is a polymer (K) wherein more than 50 wt % of recurring units (R″) are recurring units (k-B).

Non limitative examples of commercially available polymers (K) suitable for the invention include the VICTREX® PEEK polyetheretherketone, from Victrex Manufacturing Ltd. (UK), which is a polymer, the recurring units of which are recurring units (k-cl):

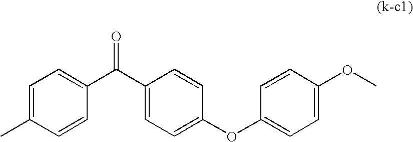

The aromatic ether ketone polymers (K) have preferably reduced viscosities in the range of from about 0.8 to about 1.8 dl/g as measured in concentrated sulfuric acid at 25° C. and at atmospheric pressure, to provide compositions having excellent processability.

Another aspect of the present invention concerns a process for manufacturing an aromatic sulfone polymer composition, said process comprising mixing:
at least one aromatic sulfone polymer (P);
a TFE polymer [polymer (F)] under the form of nanoparticles having an average primary particle size of less than 100 nm.

The process of the invention is particularly adapted for the manufacturing of the composition as above defined. Nevertheless, any other process can be suited for manufacturing the compositions of the invention.

Aromatic sulfone polymers (P) and TFE polymers (F) suitable for the process of the invention are those as above specified.

According to a first embodiment of the invention, the process comprises
(a) mixing an aqueous dispersion of the TFE polymer (F) nanoparticles with the aromatic sulfone polymer (P), as to obtain an aqueous mixture (AM);
(b) drying said aqueous mixture, as to obtain a dry mixture;
(c) melt compounding said dry mixture to obtain the polymer composition.

By “aqueous dispersion” is meant that the polymer (F) particles are stably dispersed in the aqueous medium, so that settling of the particles does not advantageously occur within the time when the dispersion will be used. Such dispersions can be obtained directly by the process known as dispersion or emulsion polymerization (i.e. latex), optionally followed by concentration and/or further addition of surfactant or can be obtained by re-dispersing dry polymer (F) nanoparticles in water, optionally in the presence of suitable surfactants or dispersing agents.

Processes comprising a microemulsion polymerization step as above detailed are particularly suitable for preparing aqueous dispersion of polymer (F) nanoparticles having an average primary particle size of less than 100 nm.

TFE polymer [polymer (F)] can be used in the first embodiment of the process according to the invention in an amount of less than 30 wt %, preferably of less than 20 wt %, more preferably of less than 10 wt %, even more preferably of less than 7 wt %, most preferably of less than 4 wt %, based on the total weight of the composition.

TFE polymer [polymer (F)] can be used in the process according to the invention in an amount of at least 0.05 wt %, preferably of at least 0.1 wt %, most preferably of at least 0.5 wt %, based on the total weight of the composition.

The aromatic sulfone polymer (P) used in the first embodiment of the process according to the present invention can be in the form of powder or of pellets, i.e. in the form of particles suitable for processing. Within the context of the present invention, the term “powder” possesses its conventional meaning, i.e. designates a solid substance in the form of tiny loose particles. The powder used in the present invention may therefore, for example, be a “crude” powder from polymerization, i.e. a pulverulent material which is the direct result of the polymerization and product recovery step. The term “pellets” mean extruded strands of polymer cut at the extruder outlet.

Preferably the polymer (P) is used under the form of powder.

Advantageously, the dry mixture is melt compounded in continuous or batch devices. Such devices are well-known to those skilled in the art.

Examples of suitable continuous devices to melt compound the dry mixture are notably screw extruders. Thus, the dry mixture and optionally other ingredients, such as additives, fillers, pigments, processing aids and the like, are advantageously fed in an extruder and extruded.

This operating method can be applied either with a view to manufacturing finished product such as, for instance, hollow bodies, pipes, laminates, calendared articles, or with a view to having available granules containing the desired polymer composition, optionally additives, fillers, pigments, processing aids in suitable proportions in the form of pellets, which facilitates a subsequent conversion into finished articles. With this latter aim, the dry mixture is advantageously extruded into strands and the strands are chopped into pellets.

According to a second preferred embodiment of the invention, the process comprises:
(a′) dissolving the aromatic sulfone polymer (P) in a suitable solvent, as to obtain a solution of polymer (P) [solution (S)];
(b′) mixing the TFE polymer (F) nanoparticles with said solution (S), as to obtain a mixture (M);
(c′) mixing a non-solvent (NS) with said mixture (M), as to obtain a coagulum (C) comprising polymer (P) and polymer (F) nanoparticles.

The aromatic sulfone polymer (P) used in the second preferred embodiment of the process according to the present invention can be in the form of powder or of pellets, i.e. in the form of particles suitable for processing. The powder used in the present invention may therefore, for example, be a “crude” powder from polymerization, i.e. a pulverulent material which is the direct result of the polymerization and product recovery step. The term “pellets” mean extruded strands of polymer cut at the extruder outlet.

The solvent capable of dissolving the polymer (P) is preferably chosen from liquids having a solubility parameter (a definition, and experimental values, for which is found in “Properties of Polymers”, D. W. Van Krevelen, 1990 Edition, pp. 200-202, and in “Polymer Handbook”, J. Brandrup and E. H. Immergut, Editors, Second Edition, p. IV-337 to IV-359) close to the solubility parameter of the polymer (P).

The non-solvent (NS), which is not capable of dissolving polymer (P), is preferably chosen so as to have a solubility parameter greatly different from that of the polymer (P). Of course, solvent and non-solvent encompass either pure substances or mixtures of substances.

Non limitative examples of suitable solvents for polymer (P) are notably ethyl acetate (EAc), methylethyl ketone (MEK), N-methylpyrrolidone (NMP), N,N-dimethylformamide (DMF), N,N-dimethylacetamide (DMAC), dimethylsulfoxide (DMSO), cresylic acid, sulfolane, formamide, cyclohexanone.

Preferably, the solvent is chosen among N-methylpyrrolidone (NMP), N,N-dimethylformamide (DMF), N,N-dimethylacetamide (DMAC), sulfolane, cyclohexanone and mixtures thereof.

According to one advantageous version of the process according to the second preferred embodiment of the present invention, a phase-separator compound (PS), generally compatible with the solvent (S) and incompatible with the non-solvent (NS), is also present during the dissolution step (a′) of the polymer (P). The reason for this is that, given the cost of the polymer (P) and of the solvent (S) and the disadvantages which could arise through their disposal in the environment, it is desirable to treat the solvent (S)/non-solvent (NS) mixture so that each of its constituents can be recovered separately. The addition of certain phase-separator compounds (PS) to the solvent (S) can facilitate separation of the solvent (S)/non-solvent (NS) mixture during solvent (S)/non-solvent recovery and recycle. The process therefore becomes more flexible, less energy-intensive and less expensive.

According to this advantageous version of the second preferred embodiment of the invention, the phase-separator compound (PS) is defined as a chemical compound which promotes the phase separation of the mixtures of solvent (S)/non-solvent (NS). According to this version of the present invention, the phase-separator compound (PS) is advantageously miscible with the solvent (S) and immiscible with the non-solvent (NS). It will therefore be substantially absent from the non-solvent-rich phase coming from the separation of the mixture of the three chemical compounds, and this can be advantageous if the non-solvent (NS) can be disposed of into the environment (for example if the non-solvent (NS) is water), and also makes it easier to obtain a coagulum (C) substantially free from this solvent. The phase-separator preferably has a solubility parameter different from that of the plastic to be dissolved.

The terms “miscible with the solvent (S)” are understood to designate solubility in the solvent generally in all volume proportions at room temperature, that is to say that one uniform liquid phase is thus formed.

The terms “immiscible with the non-solvent (NS)” are understood to designate solubility in the non-solvent of less than 10% v/v at room temperature, that is to say that phase separations occurs for concentration of 10% v/v or higher.

The phase-separator compound is preferably chosen among aliphatic or aromatic hydrocarbons, optionally halogen substituted, having from 5 to 10 carbon atoms. Excellent results have been obtained by choosing toluene as phase-separator compound (PS), in particular when the solvent (S) is cyclohexanone. Excellent results have been also obtained by choosing monochlorobenzene as phase-separator compound (PS), in particular when the solvent (S) is sulfolane.

The amount of solvent (S) (or of mixture of solvent/phase-separator) to be used is typically chosen so as to prevent the viscosity increase brought about by dissolving the polymer (P) from interfering with the good conduct of the process (filtration, etc.). In some cases, it is preferable that during the dissolution step (a′) the amount of polymer (P) does not exceed 250 g per liter of solvent (S) and of any phase-separator compound (PS), and in particular 200 g/l, preferably 100 g/l. In other cases, this content may be 250 g/l or more, more specifically 350 g/l or more.

The dissolution step [step (a′) here above] generally takes place under a pressure which is at least atmospheric pressure, more specifically at least 1.5 bar. This pressure advantageously does not exceed 10 bar, preferably 5 bar.

The dissolution step is carried out at a temperature of generally at least 75° C., more specifically at least 100° C.; said temperature generally does not exceed 125° C., more specifically 110° C.

It can moreover be advantageous to carry out at least one of steps (a′) to (c′) under an inert atmosphere, for example under nitrogen; this is generally done for avoiding any risk of explosion or of degradation of the solvent and/or of the non-solvent. Preferably all steps (a′) to (c′) here above are carried out under inter atmosphere.

The dissolution of the polymer (P) in the solvent takes place generally in a vessel or dissolution tank typically equipped with a suitable device for controlling temperature and pressure.

The TFE polymer (F) nanoparticles are generally mixed in step (b′) under the form of aqueous dispersion. The terms “aqueous dispersion” have the meaning as above defined.

Preferably the aqueous dispersion of TFE polymer (F) nanoparticles is obtained from a process comprising a microemulsion polymerization step as above detailed.

Preferably the aqueous dispersion of polymer (F) nanoparticles comprises an anionic surfactant. More preferably, the anionic surfactant is fluorinated. Even more preferably, the anionic surfactant complies with formulae (A) and (B) here below:

[Y—(CFX)ₚ—O—R_{f}—(CFX)_{p′}—COO⁻]M, wherein (Formula A)
each of X is independently F or CF₃;
p and p′, equal or different each other, are integers from 0 to 3;
R_{f} is a fluoropolyoxyalkene chain comprising from 2 to 20, preferably from 2 to 6 repeating units R°, said repeating units being chosen among the group consisting of:
   (i) —CFXO—, wherein X is F or CF₃,
   (ii) —CF₂CFXO—, wherein X is F or CF₃,
   (iii) —CF₂CF₂CF₂O—,
   (iv) —CF₂CF₂CF₂CF₂O—,
   (v) —(CF₂)ⱼ—CFZ-O— wherein j is an integer from 0 to 3 and Z is a group of general formula —OR_{f}′T₃, wherein R_{f}′ is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of each of X being independently F or CF₃; and T₃ is a C₁-C₃ perfluoroalkyl group, and mixtures thereof,
Y being a halogen, preferably Cl or F;
M being a univalent cation, preferably chosen among Na⁺, Li⁺, K⁺, NH₄⁺.

[Y—(CFX)ₚ—O—R_{f}—(CFX)_{p′}—COO⁻]₂M″, (Formula B)

wherein X, p, p′, R_{f} and Y have the same meanings as above defined and M″ is a divalent cation, preferably chosen among Ca⁺⁺, Mg⁺⁺, Zn⁺⁺.

Most preferably the anionic surfactant complies with the following formula:

Cl—(C₃F₆O)—(CF₂CF(CF₃)O)ₘ₁—(CF(CF₃)O)_{q}—(CF₂O)ₙ₁—CF₂COO⁻NH₄⁺

wherein n1=0.8% ml, q=9.2% m1, wherein the anionic surfactant has typically an average molecular weight of about 540.

Step (b′) comprising mixing the aqueous dispersion of TFE polymer (F) nanoparticles with the solution (S) can be accomplished notably either:

(b′-1) adding said dispersion to the solution (S); or
(b′-2) adding the solution (S) to said dispersion.

The TFE polymer (F) may be soluble or insoluble in the solution (S); generally, polymer (F) is insoluble in said solution.

It is preferable to obtain a suspension or solution comprising polymer (F) nanoparticles and solution (S) by suitable means and mainly by suitable stirring. This may be provided by any known device, e.g. by a mechanical stirrer, by insufflation of a gas, etc.

Should the polymer (F) nanoparticles be mixed under the form of an aqueous dispersion obtained from a process comprising a microemulsion polymerization step, it can be helpful to dilute said dispersion by addition of water.

Step (c′) comprising mixing the mixture (M) with the non-solvent (NS), also denoted hereinafter as co-coagulation step, can be accomplished notably either:

(c′-1) adding said mixture (M) to the non-solvent (NS); or
(c′-2) adding the non-solvent (NS) to said mixture (M).

It should also further be understood that steps (b′) and (c′) may be realized sequentially or simultaneously.

Should the steps (b′) and (c′) be realized simultaneously, it should be understood that mixing the TFE polymer (F) nanoparticles with solution (S), to yield mixture (M), and co-coagulation step (c′), i.e. mixing said mixture (M) with a non-solvent (NS), to yield coagulum (C), are simultaneous operations, that is to say that solution (S), TFE polymer (F) nanoparticles and non-solvent (NS) are simultaneously mixed together.

Should the steps (b′) and (c′) be realized sequentially, the non-solvent (NS) is advantageously mixed with TFE polymer (F) nanoparticles prior to mixing with solution (S). Preferably, the polymer (F) nanoparticles are under the form of aqueous dispersion, as above described, that is to say that the non-solvent (NS) is advantageously mixed with TFE polymer (F) nanoparticles aqueous dispersion prior to mixing with solution (S).

The Applicant has surprisingly found that when mixing the non-solvent (NS) with mixture (M) as above defined, polymer (F) nanoparticles advantageously separate from the solvent (S)/non-solvent (NS) mixture in the coagulum (C) comprising polymer (P).

Should the polymer (F) nanoparticles be mixed under the form of an aqueous dispersion, it can be advantageous during or prior to co-coagulation step (c′) to add an acid like HCl, CH₃COOH, H₂SO₄, HNO₃ and the like, to neutralize the anionic surfactant of the aqueous dispersion. The Applicant has found that when adding such acid, polymer (F) nanoparticles advantageously separate more easily from the solvent-non-solvent mixture to yield the coagulum (C) comprising polymer (P) and polymer (F) nanoparticles.

Advantageously, the non-solvent (NS) is at least partially miscible with water.

The terms “at least partially miscible with water” are understood to designate solubility in water generally of more than 10% v/v at room temperature, that is to say that one uniform liquid phase is thus formed.

The amount of the non-solvent (NS) can be easily determined by the skilled in the art to bring about the complete precipitation of the dissolved polymer (P).

Preferably the non-solvent (NS) comprises water.

Examples of non-solvents which have been successfully used in the process of the invention are:
water;
a mixture comprising water and acetone and/or methanol, preferably in volume ratio water/(acetone and/or methanol) of 1/1;
a mixture comprising acetone and methanol, preferably in volume ration of 1/1

According to a variant of the second preferred embodiment, co-coagulation step (c′) comprises mixing the non-solvent (NS) in both liquid and gaseous form [i.e. the liquid phase of the non-solvent (NS) and the corresponding vapor phase are mixed with mixture (M)]. The Applicant has found that when the non-solvent is mixed in step (c′) under the form of liquid and vapor, the precipitation of the polymer (P) is advantageously accelerated and the solvent (S) can be evaporated.

According to another variant of the second preferred embodiment of the invention, the solvent (S) is advantageously distilled from the mixture (M) by the addition of vapor of the non-solvent (NS).

Advantageously, the solvent (S) and the non-solvent (NS) forms an azeotropic mixture.

Typical combinations of solvent (S)/non-solvent (NS) useful for this variant are cyclohexanone/toluene in 90/10 weight ratio as solvent (S) and water, optionally water saturated with cyclohexanone as non-solvent (NS).

In this case, both toluene and cyclohexanone can form azeotropic mixtures with water, that is to say that they can be distilled off at a temperature inferior to the boiling point of water.

When water is used as non-solvent (NS) under the form of liquid/vapor mixture, the addition of steam advantageously enable distillation of the cyclohexanone/toluene used as solvent (S).

Step (c′) is preferably carried out under reduced pressure.

In the process according to the second preferred embodiment of the present invention, the coagulum (C) comprising polymer (P) and polymer (F) nanoparticles is advantageously separated from the solvent/non-solvent mixture by any known means (evaporation, centrifugation, filtration, etc. . . . ).

According to one preferred version of the process according to the invention, the solvent (S) and the non-solvent (NS) are substantially removed from the mixture (M) by evaporation at a temperature below the boiling point of the non-solvent (NS). This removal is in particular made possible by choosing substances whose boiling point is lower than that of the non-solvent and/or which give an azeotrope therewith.

In certain cases, the vapours comprising the solvent (S) and the non-solvent (NS) can undergo phase separation upon condensation; this can enable easy recovery and recycle of solvent and non-solvent.

A significant advantage of the process according to the second preferred embodiment of the invention is therefore that it can operate in a closed loop without generating waste, given that both the phase comprising the solvent (S) and that comprising the non-solvent (NS) can be recycled and reused in the process.

The process according the second preferred embodiment of the invention can further comprise further steps of washing and/or drying the coagulum (C).

The coagulum (C) is finally advantageously melt compounded in continuous or batch devices, optionally in admixture with polymer (P). The coagulum (C) can be advantageously used as masterbatch, i.e. concentrated additive composition, to be mixed with polymer (P). Should the coagulum (C) be used as masterbatch, it advantageously makes it possible to obtain highly dispersed composition comprising TFE polymer (F) nanoparticles and polymer (P).

Preferably the coagulum (C) is used as a masterbatch.

Should the coagulum be used as masterbatch, the TFE polymer [polymer (F)] is used in the second preferred embodiment of the process according to the invention in an amount of less than 50 wt %, preferably of less than 40 wt %, more preferably of less than 30 wt %, even more preferably of less than 25 wt %, most preferably of less than 20 wt %, based on the total weight of the composition.

Should the coagulum used as masterbatch, the TFE polymer [polymer (F)] is used in the second embodiment of the process according to the invention in an amount of at least 0.5 wt %, preferably of at least 2.5 wt %, most preferably of at least 5 wt %, based on the total weight of the composition.

Melt compounding devices are well-known to those skilled in the art.

Examples of suitable continuous devices to melt compound the coagulum (C) optionally in admixture with polymer (P) are notably screw extruders. Thus, the coagulum (C) optionally in admixture with polymer (P), and optionally other ingredients, such as additives, fillers, pigments, processing aids and the like, are advantageously fed in an extruder and extruded.

This operating method can be applied either with a view to manufacturing finished product such as, for instance, hollow bodies, pipes, laminates, calendared articles, or with a view to having available granules containing the desired polymer composition, optionally additives, fillers, pigments, processing aids in suitable proportions in the form of pellets, which facilitates a subsequent conversion into finished articles. With this latter aim, the coagulum (C) is advantageously extruded into strands and the strands are chopped into pellets.

Advantageously, during co-coagulation step (c′) ultrasounds are irradiated; the ultrasound irradiation is also commonly referred as ultrasonic agitation. Apparatus for sonication suitable for the process of the invention are well-known to the skilled in the art.

Advantageously, coagulum (C) is washed with a non-solvent (NS) for eliminating solvent and optionally surfactant residues.

Also during washing of coagulum (C), ultrasounds can be irradiated. Thus, washing step can be carried out under ultrasonic agitation.

It is well known that sonication generally enables size reduction of particles agglomerates. The Applicant has found that when submitting to sonication the mixture (M) during step (c′) and/or the coagulum (C) during washing steps, better dispersion of the polymer (F) nanoparticles in the coagulum (C) can be achieved.

The process according to the second embodiment of the invention provides a simple process which is notably applicable to polymer (P) in traditional commercial form (powder or pellets), which advantageously permits admixture of otherwise low-dispersibility polymer (F) nanoparticles, and which typically gives a finely-divided compound with consistent particle sizes particularly well suited to targeted applications.

Still an object of the invention is an article comprising the composition as above detailed or the composition obtained from the process as above detailed.

Advantageously the article is an injection molded article, an extrusion molded article, a machined article, a coated article or a casted article.

Non-limitative examples of articles are aircraft interior components, such as window covers, ceiling panels, sidewall panels and wall partitions, display cases, mirrors, sun visors, window shades, stowage bins, stowage doors, ceiling overhead storage lockers, serving trays, seat backs, cabin partitions, and ducts.

The invention will be described in more details with reference to the following examples, whose purpose is merely illustrative but not limitative of the scope of the invention itself.

### EXAMPLES

### Analytical Methods

### Polymer Dispersions Particle Size

The average primary particle size of the polymer dispersion has been measured by the dynamic laser light scattering (DLLS) technique according to the method described in B. Chu “Laser light scattering” Academic Press, New York (1974), following ISO 13321 Standard, using a Brookhaven Scientific Instrument, composed by the BI9000 correlator and by the BI200SM goniometer. The used light source was an argon ion laser Spectra Physics (wave length 514.5 nm).

### Differential Scanning Calorimeter

DSC measurements have been performed at a heating rate of 110° C./min, according to ASTM D 3418.

### Raw Materials

RADELL® R 5800 PPSU is a polyphenylsulfone commercially available from Solvay Advanced Polymers, L.L.C.

ALGOFLON® BMP 76/2 is an aqueous dispersion of PTFE nanoparticles obtained from microemulsion polymerization, having a solid content of 33.6% wt and an average primary particle size of 50-60 nm.

ALGOFLON® NE5 OP341 is an aqueous dispersion of PTFE nanoparticles obtained from microemulsion polymerization, having a solid content of 21.0% wt and an average primary particle size of 50 nm.

### Example 1

A 10 wt % solution of RADELL® R-5800 polyphenylsulfone in 1-methyl-2-pyrrolidinone (NMP) was prepared by dissolving under stirring 10 g of PPSU in 90 g of NMP at 25° C.

To a 1000 ml Waring Blender equipped with an explosion-proof Eberbach electric drive and variable-speed controller, 7.44 g of Algoflon® BMP 76/2 aqueous dispersion (33.6% PTFE; 50-60 nm average primary particle size) was added, followed by a non-solvent mixture consisting of 200 g of acetone and 200 g of de-ionized water.

With the Waring Blender set at 9000 rpm, the solution of PPSU in NMP was added to the ALGOFLON® BMP 76/2 and non-solvent mixture over a period of two minutes. Agitation was continued for an additional two minutes to achieve a small particle size coagulum.

The coagulum was separated from the solvent/non-solvent mixture by vacuum filtration through a porcelain Büchner perforated plate filter using Whatman 541 hardened ashless filter paper (110 mm diameter; 20-25 μm average pore size).

The recovered coagulum was charged to the Waring Blender and slurried in 400 g of acetone. The washed coagulum was filtered and returned to the blender where it was washed two times with hot (90° C.) de-ionized water. The recovered coagulum was then charged to an Erlenmeyer flask equipped with a water-jacketed condenser, together with 1000 g of de-ionized water. The resulting slurry was heated to 10° C. and maintained at this temperature for one hour. The coagulum was separated from the water/solvent liquor and returned to the Erlenmeyer for three additional solvent extraction operations. The recovered coagulum was dried overnight in a vacuum oven (27 in. Hg) at 120° C.

The resulting coagulum contained from 8.43-9.88 wt % fluorine and 11 ppm residual NMP solvent.

### Example 2

Same procedure as Example 1, but the non-solvent mixture consists of 200 g of acetone and 200 g of methanol. The recovered coagulum contained from 14.01-19.23 wt % fluorine and 9 ppm residual NMP.

### Example 3

Same procedure as Example, but the co-coagulation was carried at 2500 rpm. The recovered coagulum contained from 3.18-3.54 wt % fluorine and 10 ppm residual NMP.

### Example 4

A 10 wt % solution of RADELL® R-5800 PPSU in 1-methyl-2-pyrrolidinone (NMP) was prepared by dissolving under stirring 10 g of PPSU in 90 g of NMP at 25° C. To this solution, a mixture of 7.44 g of ALGOFLON® BMP 76/2 aqueous dispersion (33.6% PTFE; 50-60 nm average primary particle size) in 122.50 g NMP was added under low shear conditions to prevent agglomeration of the nano-PTFE particles.

To a 1000 ml Waring Blender equipped with an explosion-proof Eberbach electric drive and variable-speed controller, a non-solvent mixture was added consisting of 459.88 g of acetone and 459.88 g of de-ionized water.

With the Waring Blender set at 9000 rpm, the solution of PPSU/nano-PTFE/NMP was added to the non-solvent mixture over a period of two minutes. Agitation was continued for an additional two minutes to achieve a small particle size coagulum.

The coagulum was separated from the solvent/non-solvent mixture by vacuum filtration through a porcelain Büchner perforated plate filter using Whatman 541 hardened ashless filter paper (110 mm diameter; 20-25 μm average pore size).

The recovered coagulum was charged to the Waring Blender and slurried in 400 g of acetone. The washed coagulum was filtered and returned to the blender where it was washed once with hot (90° C.) de-ionized water. The recovered coagulum was then charged to an Erlenmeyer flask equipped with a water-jacketed condenser, together with 1000 g of de-ionized water. The resulting slurry was heated to 10° C. and maintained at this temperature for one hour. The coagulum was separated from the water/solvent liquor and returned to the Erlenmeyer for three additional solvent extraction operations. The recovered coagulum was dried overnight in a vacuum oven (27 in. Hg) at 120° C.

The resulting coagulum contained from 13.20 wt % fluorine and 10 ppm residual NMP solvent.

### Example 5

A 5 wt % solution of RADELL® R-5800 PPSU in 1-methyl-2-pyrrolidinone (NMP) was prepared by dissolving under stirring 5 g of PPSU in 95 g of methylene chloride at 25° C.

A 2 wt % solution of nano-PTFE was prepared by mixing 5.295 g of Algoflon® NE50P341 aqueous dispersion (21% PTFE; 50 nm average primary particle size) with 50.305 g de-ionized water.

The aqueous PTFE dispersion was added to a 1000 ml Waring Blender equipped with an explosion-proof Eberbach electric drive and variable-speed controller set at 1500 rpm. The PPSU solution (50.00 g) was then charged to the blender to obtain a dispersion of PPSU/CH₂Cl₂ droplets in the aqueous PTFE solution. The blender speed was subsequently increased to 2500 rpm and then 5000 rpm to form a small droplet size dispersion.

With the Waring Blender speed increased to 9000 rpm, 422.40 g of methanol non-solvent was charged to the blender over a period of two minutes. Agitation was continued for an additional two minutes to achieve a small particle size coagulum.

The coagulum was separated from the solvent/non-solvent mixture by vacuum filtration through a porcelain Büchner perforated plate filter using Whatman 541 hardened ashless filter paper (110 mm diameter; 20-25 μm average pore size).

The recovered coagulum was charged to the Waring Blender and slurried in 422.40 g of methanol. The washed coagulum was filtered and returned to the blender where it received a second wash with 422.40 g of methanol. The recovered coagulum was dried overnight in a vacuum oven (27 in. Hg) at 120° C.

### Example 6

A solution of RADELL® R PPSU in a mixture of cyclohexanone/toluene (90/10 wt/wt) was prepared by heating under stirring at 100° C. 200 g of PPSU in 2000 g of solvent mixture for 1 hour; the solution was then cooled to 70° C.

In a double jacket reactor equipped with a mechanical stirrer, temperature and pressure regulators and means for introduction of steam, 2325 of degassed water and 175 g of cyclohexanone were introduced for forming the non-solvent liquid mixture and kept under stirring (600 rpm) at 60° C. While keeping said mixture under stirring at 600 rpm, 9.0 g of the ALGOFLON® BMP 76/2 aqueous dispersion were added.

To this suspension kept under stirring, the solution of RADELL® R PPSU was then added via a dip tube. The addition was completed after 5 minutes.

The mixture was then acidified with 10 ml of an aqueous solution of HCl (0.1 M).

Pressure was then set at 400 mbar and steam was injected with a ΔP of 800 mbar; the toluene/water azeotropic mixture and then the cyclohexanone/water azeotropic mixture were distilled off and a coagulum was obtained.

The so-obtained coagulum slurry was then filtered from the aqueous phase on a polyamide screen (75 μm). The recovered product was dried overnight at 100° C. under reduced pressure until constant weight.

FIG. 2 shows a microscopy picture of the dried composition comprising RADELL® PPSU and PTFE nanoparticles. Regular morphology comprising particles of roughly 100 μm of size was obtained.

### Example 7

A solution of RADELL® R PPSU in a mixture of cyclohexanone/toluene (90/10 wt/wt) was prepared by heating under stirring at 100° C. 200 g of PPSU in 2000 g of solvent mixture for 1 hour; the solution was then cooled to 70° C. and introduced in a double-jacked reactor equipped with a mechanical stirrer, temperature and pressure regulators and means for introduction of steam.

Then 15.0 g of ALGOFLON® NE5 aqueous dispersion and 5 g of water were added.

The mixture was acidified by addition of 20 ml of a HCl aqueous solution (0.1 M) and kept under stirring at 70° C. for 15 minutes.

Pressure was then set at 400 mbar and 2000 g of water were injected at a rate of 15 L/h, and steam with a ΔP of 800 mbar; the toluene/water azeotropic mixture and then the cyclohexanone/water azeotropic mixture were distilled off and a coagulum was obtained.

The so-obtained coagulum slurry was then filtered from the aqueous phase on a polyamide screen (75 μm). The recovered product was dried overnight at 100° C. under reduced pressure until constant weight.

1- An aromatic sulfone polymer composition comprising:
at least one aromatic sulfone polymer [polymer (P)], i.e. a polymer comprising recurring units (R), at least 50% wt of said recurring units comprising at least one group of formula 1: 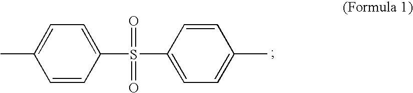
from 0.02 to less than 10 wt % of a tetrafluoroethylene (TFE) polymer [polymer (F)] under the form of nanoparticles, based on the total weight of (P) and (F), wherein said nanoparticles have an average primary particle size of less than 100 nm.

2- The composition according to claim 1, said composition having a transparency of more than 40%, according to ASTM P 1746, when measured on sheets having a thickness of 100 μm.

3- The composition according to claim 1, having a two minutes total heat release (THR) less than or equal to 65 KW.min/m² and a maximum heat release rate (HRR) of less than or equal to 65 KW/m².

4- The composition according to claim 1, wherein the polymer (F) is chosen among homopolymers of tetrafluoroethylene (TFE) or copolymers of TFE with at least one ethylenically unsaturated comonomer [comonomer (CM)], said comonomer being present in the TFE copolymer in an amount from 0.01 to 3% by moles, preferably from 0.01 to 1% by moles, with respect to the total moles of TFE and comonomer (CM).

5- The composition according to claim 4, wherein the comonomer (CM) is selected from the group consisting of hexafluoropropylene, perfluoromethylvinylether, perfluoropropylvinylether, perfluorodioxole of formula: 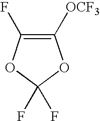
and mixtures thereof.

6- The composition according to claim 1, wherein at least 50% wt of the recurring units (R) of aromatic sulfone polymer (P) are recurring units (R1), in their imide form (R1-A) and/or amic acid forms [(R1-B) and (R1—C)]: 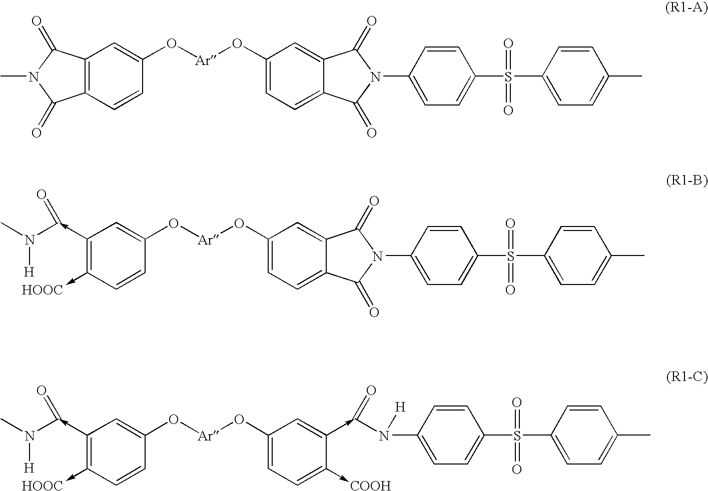
wherein
the → denotes isomerism so that in any recurring unit the groups to which the arrows point may exist as shown or in an interchanged position;
Ar″ is chosen among the following structures 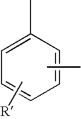
with the linking groups being in ortho, meta or para position and R′ being a hydrogen atom or an alkyl radical comprising from 1 to 6 carbon atoms, 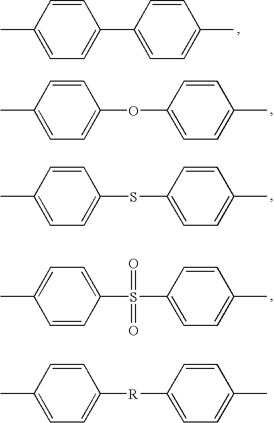
with R being an aliphatic divalent group of up to 6 carbon atoms,
and mixtures thereof.

7- The composition according to claim 1, wherein at least 50% wt of the recurring units (R) of aromatic sulfone polymer (P) are recurring units (R2) and/or recurring units (R3)) 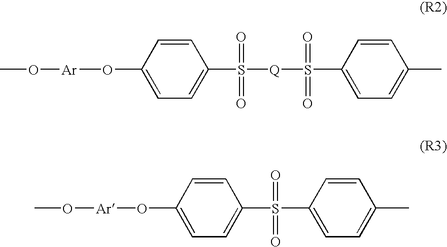
wherein:
Q is a group chosen among the following structures 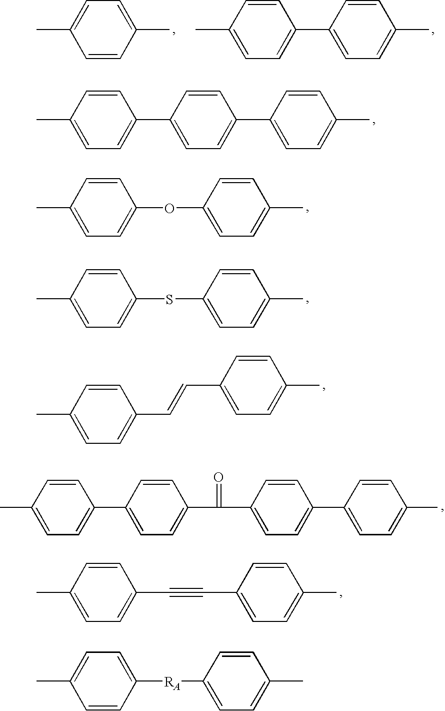
with R_{A} being 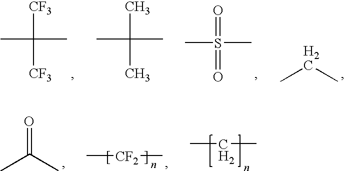
with n=integer from 1 to 6, or an aliphatic divalent group, linear or branched, of up to 6 carbon atoms;
and mixtures thereof;
Ar is a group chosen among the following structures 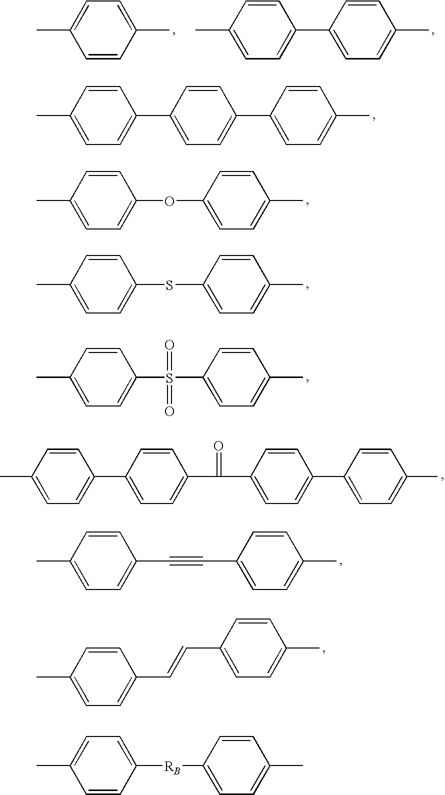
with R_{B} being: 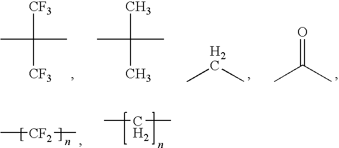
with n=integer from 1 to 6, or an aliphatic divalent group, linear or branched, of up to 6 carbon atoms;
and mixtures thereof;
Ar′ is a group chosen among the following structures 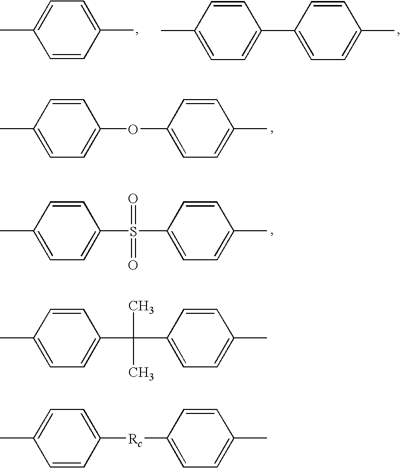
with R_{C} being: 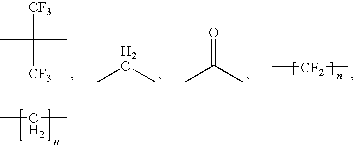
with n=integer from 1 to 6, or an aliphatic divalent group, linear or branched, of up to 6 carbon atoms;
and mixtures thereof.

8- A process for manufacturing an aromatic sulfone polymer composition, said process comprising mixing:
at least one aromatic sulfone polymer (P); and
a TFE polymer [polymer (F)] under the form of nanoparticles having an average primary particle size of less than 100 nm.

9- The process of claim 8, said process comprising
(a) mixing an aqueous dispersion of the TFE polymer (F) nanoparticles with the aromatic sulfone polymer (P), as to obtain an aqueous mixture (AM);
(b) drying said aqueous mixture, as to obtain a dry mixture; and
(c) melt compounding said dry mixture to obtain the polymer composition.

10. The process of claim 8, said process comprising:
(a′) dissolving the aromatic sulfone polymer (P) in a suitable solvent, as to obtain a solution of polymer (P) [solution (S)];
(b′) mixing the TFE polymer (F) nanoparticles with said solution (S), as to obtain a mixture (M); and
(c′) mixing a non-solvent (NS) with said mixture (M), as to obtain a coagulum (C) comprising polymer (P) and polymer (F) nanoparticles.

11- An article comprising the composition according to claim 1 or the composition obtained from the process according to claim 8.
